(19) United States
(12) Patent Application Publication
(10) Pub. No.: US 2025/0371356 A1
(43) Pub. Date: Dec. 4, 2025

(54) PROMPT TEMPLATE OPTIMIZATION WITH NON-PARAMETERIZED GRADIENT DESCENT FOR ENTERPRISE-LEVEL AI USE CASES

(71) Applicant: SAP SE, Walldorf (DE)

(72) Inventors: Junxiang Jia, Singapore (SG); Alexy Xena Hackmann, Singapore (SG); Zeling Long, Singapore (SG); Kang Yee Lim, Singapore (SG); Zhen Shu, Singapore (SG)

(21) Appl. No.: 18/731,450

(22) Filed: Jun. 3, 2024

(51) Int. Cl. G06N 3/0895

(52) U.S. Cl. CPC G06N 3/0895

(57) ABSTRACT

Methods, systems, and computer-readable storage media for providing an initial version of a prompt template, the prompt template including dynamic input and first static input, generating a prompt using the initial version of the prompt template at least partially by populating the dynamic input with training data, receiving, from a large language model (LLM), an output that is responsive to the prompt, providing an evaluation at least partially based on the output, and selectively updating the prompt template to provide an updated version of the prompt template by prompting the LLM at least partially based on the evaluation, the updated version of the prompt template including second static input that is generated by the LLM and that is different from the first static input.

### BACKGROUND

In the field of artificial intelligence (AI), so-called generative AI (GAI) has recently seen an explosion in popularity. GAI can be described as including so-called foundation models that generate content based on training data. For example, foundation models can include large language models (LLMs), which are a form of GAI that can be used to generate text for a variety of use cases. LLMs have demonstrated remarkable proficiency as general-purpose agents (e.g., chatbots) with extensive capacities for text generation, classification, detection, and the like. For enterprises, these capabilities significantly speed up iterations of AI use cases when compared to conventional machine learning (ML) models. However, integrating LLMs into enterprise platforms is a non-trivial task, as LLMs can present various technical challenges and can have disadvantages that have to be managed.

### SUMMARY

Implementations of the present disclosure are directed to an automatic prompt optimization (APO) platform for optimizing prompt templates. More particularly, implementations of the present disclosure are directed to an APO platform that optimizes prompt templates using a non-parameterized version of gradient descent.

In some implementations, actions include providing an initial version of a prompt template, the prompt template including dynamic input and first static input, generating a prompt using the initial version of the prompt template at least partially by populating the dynamic input with training data, receiving, from a large language model (LLM), an output that is responsive to the prompt, providing an evaluation at least partially based on the output, and selectively updating the prompt template to provide an updated version of the prompt template by prompting the LLM at least partially based on the evaluation, the updated version of the prompt template including second static input that is generated by the LLM and that is different from the first static input. Other implementations of this aspect include corresponding systems, apparatus, and computer programs, configured to perform the actions of the methods, encoded on computer storage devices.

These and other implementations can each optionally include one or more of the following features: the prompt template is updated at least partially in response to a score of the evaluation indicating that the prompt template is to be updated, the score being provided by the LLM in response to an evaluation prompt; two or more iterations of updating the prompt template are performed until a score exceeds a threshold score, the score representing an evaluation metric associated with the prompt template; two or more iterations of updating the prompt template are performed until a value of a score fails to exceed a prior value of the score, the score representing an evaluation metric associated with the prompt template; updating the prompt template includes prompting the LLM using an update prompt that is at least partially based on the evaluation and the prompt template, the LLM returning the updated version of the prompt template in response to the update prompt; the evaluation is provided by prompting the LLM using an evaluation prompt that is at least partially based on the output, the LLM returning the evaluation in response to the evaluation prompt; and the prompt is included in a batch of prompts used to prompt the LLM, the output is included in a batch of outputs returned from the LLM, and the evaluation is determined from a batch of evaluations.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts an example conceptual architecture in accordance with implementations of the present disclosure.

FIG. 4 depicts an example process that can be executed in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to an automatic prompt optimization (APO) platform for optimizing prompt templates. More particularly, implementations of the present disclosure are directed to an APO platform that optimizes prompt templates using a non-parameterized version of gradient descent, in which a large language model (LLM) is used to evaluate an output generated using a prompt template and formulating a loss that is to be minimized through optimization.

Implementations can include actions of providing an initial version of a prompt template, the prompt template including dynamic input and first static input, generating a prompt using the initial version of the prompt template at least partially by populating the dynamic input with training data, receiving, from a large language model (LLM), an output that is responsive to the prompt, providing an evaluation at least partially based on the output, and selectively updating the prompt template to provide an updated version of the prompt template by prompting the LLM at least partially based on the evaluation, the updated version of the prompt template including second static input that is generated by the LLM and that is different from the first static input.

To provide further context for implementations of the present disclosure, and as introduced above, in the field of artificial intelligence (AI), so-called generative AI (GAI) has recently seen an explosion in popularity. GAI can be described as including so-called foundation models that generate content based on training data. For example, foundation models can include LLMs, which are a form of GAI that can be used to generate text for a variety of use cases. LLMs have demonstrated remarkable proficiency as general-purpose agents (e.g., chatbots) with extensive capacities for text generation, classification, detection, and the like. For enterprises, these capabilities significantly speed up iterations of AI use cases when compared to conventional machine learning (ML) models.

However, integrating LLMs into enterprise platforms is a non-trivial task. One reason for this is that LLMs can present various technical challenges and can have disadvantages that have to be managed. For example, the effectiveness of an LLM is predominantly reliant on prompts, which are the input to the LLM. Well-constructed and detailed prompts enable the LLM to provide higher quality responses. However, prompts can be relatively complex for many enterprise-level use cases. For example, prompts can involve extensive directives, sophisticated instructions, and input data to provide context for the LLM.

In many use cases, prompts that are to be input to a LLM are generated using prompt templates. In some examples, prompt templates include static input and dynamic input. Here, the static input is the same for each prompt and each invocation of the LLM (each time the LLM is prompted), and the dynamic input includes data dictated by user interaction for each invocation of the LLM. That is, the dynamic input can change for each prompt and each invocation of the LLM. Achieving the desired output from the LLM responsive to the prompts necessitates a high degree of precision. To achieve this, prompt templates are traditionally provisioned through a time- and resource-consuming cycle of trial and error. Presently, the optimization of prompt templates requires substantial consumption of resources including technical resources (processors, memory, bandwidth).

In view of the above context, implementations of the present disclosure provide an APO platform for optimizing prompt templates using a non-parameterized version of gradient descent. Gradient descent can be described as an optimization algorithm for determining a local minimum of a differentiable function. Gradient descent is used in training of conventional ML models to find values of parameters of the ML model that minimize a loss (e.g., determined by a loss function).

As described in further detail herein, the APO platform of the present disclosure optimizes prompt templates by simulating the training process of a conventional ML model and utilizing a LLM to evaluate an output generated using a prompt template. This evaluation formulates a loss that is to be minimized through optimization. Through an optimization process, the LLM is guided to update the prompt template over multiple iterations based on the loss. In the enterprise context, the effectiveness of the optimization process of the present disclosure can be seen after relatively few iterations, which result in prompt templates consistently providing improvements across various evaluation metrics. Among other improvements, the APO platform of the present disclosure significantly accelerates fine-tuning of prompt templates and the development lifecycle of enterprise-level AI applications while conserving technical resources.

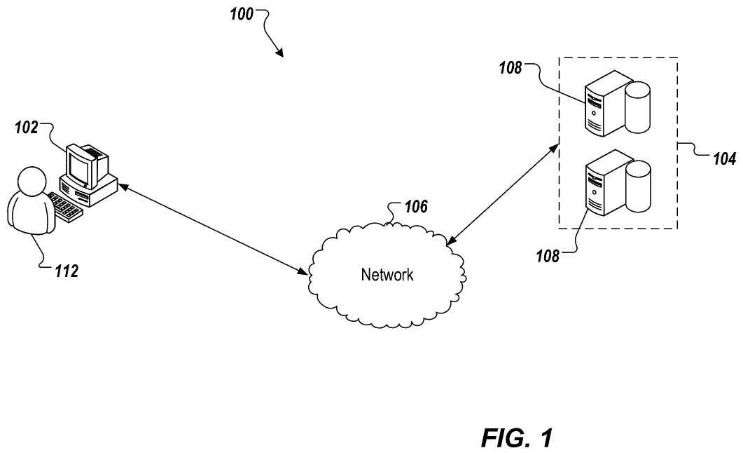

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host an APO platform for optimizing prompt templates. For example, and as described in further detail herein, the APO platform processes prompt templates using a non-parameterized version of gradient descent, which is used in training of conventional ML models. More particularly, the APO platform of the present disclosure optimizes prompt templates by simulating the training process of conventional ML models.

To provide context, a traditional ML training process involves initialization, forward propagation, loss calculation, updating through backward propagation, iterations, and batch gradient descent. In initialization, values weights and biases of the ML model are randomly initialized. In forward propagation, training data is input to the ML model, which provides a prediction as output. In loss calculation, a loss is determined as a difference between the predicted value output by the ML model and a ground-truth value provided in the training data. In updating through backward propagation, a gradient is determined based on the loss (error) values of the weights and biases of the ML model are updated. The training process is repeated over multiple iterations to optimize the values of the weights and biases. In batch gradient descent, a batch of the training data is processed in one iteration, leading to a smoother and more stable convergence path to optimization.

In accordance with implementations of the present disclosure, optimization of a prompt template follows similar steps, but in a non-parameterized approach. More particularly, and as described in further detail herein, text of the prompt template is iteratively updated toward optimization (as opposed to the weights and biases in a conventional ML model). For example, in initialization, the starting point is a prompt template that is to be optimized. The prompt template can be human-generated and/or machine-generated (e.g., using a LLM).

In forward propagation, an output is provided from a LLM using a prompt that is generated using the prompt template and input data (e.g., the input data populating dynamic input of the prompt template). In loss calculation, a LLM is used as a judge to evaluate the output of the LLM (e.g., against a desired output (ground-truth)), the LLM returning a textual, natural language criticism on deficiencies of the output, as well as a score representative of an evaluation metric. In updating through backward propagation, the criticism is used to generate an updated version of the prompt template using a LLM. Unlike traditional ML training, implementations of the present disclosure use a non-parameterized approach, in which text of the prompt template is iteratively updated. The optimization process is repeated over multiple iterations to achieve a prompt template that generates an optimal output from the LLM on the training data. In batch gradient descent, a LLM is used as an evaluator to summarize all criticism texts in each batch.

In some implementations, optimization is executed using a reference-based evaluation that includes an evaluation metric of groundness. Groundness can be described as measure of how well the output of the LLM is grounded in the knowledge corpus used to train the LLM. In reference-based evaluation, the LLM is prompted using an evaluation prompt to evaluate output of the LLM responsive to a prompt provided from the prompt template that is being optimized. An example evaluation prompt can be provided as:

| | |
|---|---|
| {PERSONA} | Please act as an impartial judge and evaluate |
| | the quality of the responses provided by an |
| | AI assistant. Your evaluation should consider |
| | correctness and helpfulness. You will be |
| | given a reference answer, and the assistant's |
| | answer. |
| {TASK} | Your job is to compare the assistant's answer |
| | with the reference answer and rate the |
| | assistant's answer on one metric. Please make |
| | sure you read and understand these |
| | instructions carefully. |
| {DATA} | {LLM output} |
| | {Reference text} |
| {BIAS CONTROL} | Avoid any position biases and ensure that the |
| | order in which the responses were presented |
| | does not influence your decision. Do not |
| | allow the length of the responses to |
| | influence your evaluation. Do not favor |
| | certain names of the assistants. Be as |
| | objective as possible. |
| {OUTPUT CONTROL} | After evaluating, output your final verdict |
| | by strictly following JSON format: |
| | {. . .} |

### Example Evaluation Prompt for Reference-Based Evaluation

Here, {LLM output} is the output provided from the LLM based on the prompt and {Reference text} is a desired output corresponding to the training data used to generate the prompt.

In some implementations, optimization is executed using reference-free evaluation that includes a set of metrics, which can include conciseness, coherence, and one or more customized metrics. Conciseness can be described as a measure of how concise an output of a LLM is. Coherence can be described as a measure of how coherent an output of a LLM is. In reference-free evaluation, the LLM is prompted using an evaluation prompt to evaluate output of the LLM responsive to a prompt template provided from the prompt that is being optimized. An example evaluation prompt can be provided as:

| | |
|---|---|
| {PERSONA} | Please act as an impartial judge and evaluate |
| | the quality of the responses provided by an |
| | AI assistant. Your evaluation should consider |
| | correctness and helpfulness. You will be |
| | given a reference answer, and the assistant's |
| | answer. |
| {TASK} | Answer: Is the submission concise and to the |
| | point? |
| {TASK} | Answer: Is the submission coherent, well- |
| | structured, and organized? |
| {TASK} | Answer: [customized question] |
| {DATA} | {LLM output} |
| {BIAS CONTROL} | Avoid any position biases and ensure that the |
| | order in which the responses were presented |
| | does not influence your decision. Do not |
| | allow the length of the responses to |
| | influence your evaluation. Do not favor |
| | certain names of the assistants. Be as |
| | objective as possible. |
| {OUTPUT CONTROL} | After evaluating, output your final verdict |
| | by strictly following JSON format: |
| | {. . .} |

### Example Evaluation Prompt for Reference-Free Evaluation

Although multiple tasks are depicted in the example evaluation prompt for reference-free evaluation, it is contemplated that a single task can be provided.

Implementations of the present disclosure are described in further detail herein with reference to non-limiting example use cases, prompt templates, training data, LLMs, and the like. It is contemplated, however, that implementations of the present disclosure can be realized with any appropriate use cases and using any appropriate prompt templates, training data, LLMs, and the like.

In an example use case, the LLM is to generate a funny story based on a topic and a prompt template is to be optimized for this task. An example prompt template can be provided as:
Write a definition about {topic}.
   This can be an initial version of the prompt template that is to be optimized in accordance with implementations of the present disclosure. In some examples, a set of topics are provided as training data for optimization of the prompt template. In some examples, the training data can include, for each topic, a desired output. Table 1 provides example training data:

TABLE 1
Example Training Data

| Topic | Desired Output |
|---|---|
| Cell phone | Once upon a time, there was a cell phone named |
| | Sammy. Sammy was known for his “magical” auto- |
| | correct powers, which often led to side- |
| | splitting texting mishaps. One fine day, his |
| | owner, Mr. Parker, was texting his girlfriend |
| | and wanted to say, “You look as beautiful as a |
| | full moon tonight.” A second later, Parker was |
| | shocked to see Sammy had transformed his sweet |
| | phrase into, “You look as bloated as a full |
| | balloon tonight.” Then as Parker scrambled to |
| | correct the outrageous auto-correct, Sammy |
| | again interfered and wrote, “Wait, I meant |
| | foolish baboon tonight.” That evening Sammy got |
| | the honor of being the first-ever cell phone to |
| | be served a dessert; an immediate triple- |
| | layered face-cake, courtesy of Mr. Parker's |
| | girlfriend. |
| Table | Once upon a time, a spunky little table named |
| | Timothy decided to create some entertainment in |
| | the boring furniture store. After-hours, when |
| | the humans were long gone, Timothy started |
| | marching around the store, cracking table jokes |
| | to the other furniture. “Why was the chair |
| | always scared of me?” he asked, chuckling. |
| | “Because it thought I always bring food to the |
| | table!” The room roared with laughter, even the |
| | cranky old wardrobe gave a chuckle. Timothy, |
| | proud of his comic skills, strutted around |
| | causing such a ruckus that he didn't notice the |
| | pesky rug named Ralph on the floor. With a loud |
| | “clatter and crack,” Timothy tripped, landing |
| | flat on his surface. The room froze for a |
| | moment, then burst out laughing, even Timothy |
| | couldn't help but join in, shifting his laugh |
| | into a guffaw, “Well, I guess tonight, the joke |
| | was on table!” |
| . . . | . . . |

Continuing with the non-limiting examples above, the initial prompt template can be optimized over one or more iterations. For example, in a first iteration, a prompt can be generated using the initial prompt template and the training data. For example, a prompt can be provided as:
Write a definition about cell phone.
   In this example, {TOPIC} has been substituted with cell phone from the training data. The prompt is processed by a LLM, which generates an output that is responsive to the prompt. An example output can be provided as:
A cell phone, also known as a mobile phone, is a portable device that allows for telecommunication over long distances. It operates over a wireless network and enables users to make and receive calls, send text messages, access the internet, take photos, play music, and use various applications. It is powered by a rechargeable battery and its functionality can range from basic communication to advanced computing capabilities.

In accordance with implementations of the present disclosure, the LLM is used to evaluate the output (e.g., loss using LLM-as-a-Judge). For example, an evaluation prompt is generated, which includes the output and tasks the LLM with evaluating the output and provide scores for one or more evaluation metrics. By way of non-limiting example, the example evaluation prompt for reference-based evaluation can be considered, where {LLM output} is the output of the LLM that is being evaluated and {Reference text} is the desired output provided for the training data. The LLM can provide the following example evaluation response:
Customized Groundness: 0.1
Criticism: The assistant's answer provides a factual and technical description of what a cell phone is and what it does. The reference answer, on the other hand, is a fictional story about a cell phone character named Sammy. While both answers discuss cell phones, the content, context, and style are vastly different. The assistant's answer does not match the reference answer in terms of storytelling, characters, or moral lesson. The only similarity is the mention of a cell phone, hence the low score.
   Here, a groundness score of 0.1 is provided for the groundness evaluation metric.

In accordance with implementations of the present disclosure, the LLM is used to generate an updated version of the prompt template based on the evaluation response. An example updated version of the example prompt template provided above can include:
Create a humorous or fictional narrative about {topic}.
   In some examples, the updated version of the prompt template is generated by the LLM. For example, the LLM is prompted to generate an updated version of the prompt template based on the evaluation response. An example of an update prompt for generating the updated version of the prompt template can be provided as:
You are an experienced prompt engineer specialized in writing prompt for large language model text generation. Your task is to generate a better prompt template based on the current prompt, ground truth sample response, and evaluation results given below. Only output the prompt template and do not output anything else.
Within the following triple backticks is current prompt template:
. . .
{prompt_template}
. . .
Within the following triple backticks is the LLM response from the current prompt template:
. . .
{prompt_response}
. . .
Within the following triple backticks is the sample response that the best prompt should return:
. . .
{reference text}
. . .

Within the following triple backticks is the evaluation result based on the response and sample output:
. . .
{evaluation results}
. . .

Another iteration of the optimization process can be executed using the updated version of the prompt template to provide a groundness score for the updated version of the prompt template. Continuing with the examples above, a groundness score of 0.5, with natural language criticism, can be provided for the updated version of the prompt template. In some examples, iterations of the optimization process are repeated until the groundness score exceeds a threshold score.

The above-discussed examples use reference-based evaluation. However, and as introduced above, reference-free evaluation can be used. For example, the example evaluation prompt for reference-free evaluation can be considered, where {LLM output} is the output of the LLM that is being evaluated, but no desired output is provided from the training data. Further, a task can be defined, such as a customized task (e.g., Answer: Is the output funny?). The LLM can provide the following example evaluation response:
Funniness: 0.1
Criticism: The assistant's response is informative and factual, but it does not contain any humor or joke. It's a straightforward explanation of what a cell phone is.

As discussed above, the LLM is used to generate an updated version of the prompt template based on the evaluation response. Continuing with this example, the following example updated version of the prompt template can be provided:
Provide a humorous and informative definition about {topic}.

Another iteration of the optimization process can be executed using the updated version of the prompt template to provide a funniness score for the updated version of the prompt template. Continuing with the examples above, a funniness score of 0.7, with natural language criticism, can be provided for the updated version of the prompt template. In some examples, iterations of the optimization process are repeated until the funniness score exceeds a threshold score.

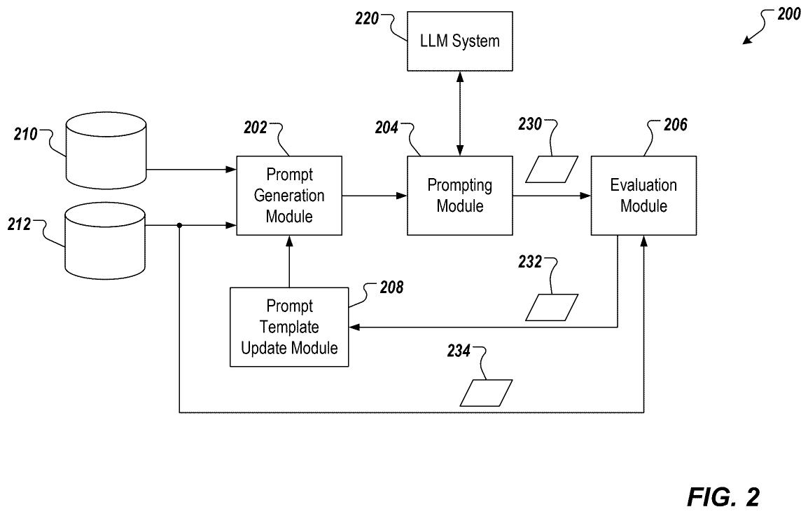

FIG. 2 depicts an example conceptual architecture 200 in accordance with implementations of the present disclosure. In the depicted example, the conceptual architecture 200 includes a prompt generation module 202, a prompting module 204, an evaluation module 206, a prompt template update module 208, a data store 210, and a prompt template data store 212. The conceptual architecture 200 also includes a LLM system 220. In some examples, the LLM system 220 is provided by a third-party and executes a LLM. An example LLM can include, without limitation, ChatGPT. In some examples, the LLM system 220 is accessed through one or more application programming interfaces (APIs).

In some implementations, the data store 210 stores prompt templates that are to be optimized. For example, the prompt templates can each include an initial version of a prompt template that is to be optimized in accordance with implementations of the present disclosure. For example, and with reference to the non-limiting examples above, a prompt template can include Write a definition about {topic}. In some implementations, the data store 212 stores training data that can be used to optimize prompt templates. For example, the data store 212 can store training data that includes data that is to be used as dynamic input to fill in placeholders of prompt templates. In some examples, the data store 212 stores desired output. For example, and with reference to the non-limiting examples above, the training data can include a set of topics and, for each topic, a desired output.

In some implementations, in an iteration (i) the prompt generation module 202 generates a prompt using a prompt template from the data store 210 and training data from the data store 212. For example, and with reference to the non-limiting examples above, a prompt can include Write a definition about cell phone. As another example, and with reference to the non-limiting examples above, a prompt can include Write a definition about table. In some examples, the prompt generation module 202 generates the prompt by replacing placeholders with training data (e.g., as dynamic input).

In some implementations, the prompting module 204 prompts the LLM of the LLM system 220 using the prompt from the prompt generation module 202. For example, the prompting module 204 can make an API call to the LLM system 220, the call including the prompt. The LLM system 220 processes the prompt and returns a response as output 230, which is provided to the evaluation module 206.

In some implementations, the evaluation module 206 provides an evaluation 232 that evaluates the output 230. For example, the evaluation 232 can include one or more evaluation metrics and a criticism (e.g., in natural language). In some examples, the evaluation 232 is provided from the LLM system 220 in response to an evaluation prompt provided by the evaluation module 206. For example, the evaluation module 206 can generate the evaluation prompt at least partially based on the output 230 and prompts the LLM of the LLM system 220 using the evaluation prompt. For example, the evaluation module 206 can make an API call to the LLM system 220, the call including the evaluation prompt, where the LLM system 220 returns the evaluation 232.

In some implementations, the evaluation 232 is a reference-based evaluation, as described herein. For example, a desired output 234 that corresponds to the training data used to generate the evaluation prompt is provided to the evaluation module 206. The evaluation module 206 generates an evaluation prompt at least partially based on the desired output 234. In this example, the evaluation 232 is a reference-based evaluation that includes a groundness score and a criticism.

In some implementations, the evaluation 232 is a reference-free evaluation, as described herein. For example, the evaluation module 206 generates an evaluation prompt that is absent a desired output. In this example, the evaluation 232 is a reference-free evaluation that includes a criticism and one or more of a conciseness score, a coherence scores, and a custom score (e.g., funniness).

In accordance with implementations of the present disclosure, the prompt template update module 208 selectively updates the prompt template that has been used to provide the output 230. For example, if an evaluation metric (e.g., groundness score, conciseness score, coherence scores, custom score) meets a respective threshold score, it can be determined that the prompt template need not be updated (e.g., the prompt template is considered optimized). If an evaluation metric (e.g., groundness score, conciseness score, coherence scores, custom score) does not meet a respective threshold score, it can be determined that the prompt template is to be updated (e.g., the prompt template is considered non-optimized).

If the prompt template is to be updated, the prompt template update module 208 provides an update prompt that is at least partially based on the evaluation 232. For example, the update prompt can include the criticism of the evaluation 232. In some examples, the update prompt is at least partially based on the prompt template. For example, the update prompt can request that an updated version of the prompt template be provided based on the criticism. In some examples, the prompt template update module 208 can make an API call to the LLM system 220, the call including the update prompt, where the LLM system 220 returns the updated version of the prompt template. The updated version of the prompt template is provided to the prompt generation module 202, which executes a next iteration (i+1) of optimizing the prompt template.

In some instances, overfitting can occur, in which optimization of the prompt template results in the prompt template becoming too specific to be generally applicable. Continuing with the example above, too many iterations of the optimization process can result in the following example prompt template:
Create a humorous and engaging narrative about {topic}, where the protagonist is an old-fashioned flip phone in a world of high-tech smartphones. The story should center around a friendly competition between the flip phone and a newly released, technologically advanced smartphone. The competition is about who can deliver a message to the other side of the town the quickest, with the flip phone winning by using a simple SMS. The story should end with a lesson highlighting the importance of humor and humility. The flip phone, known for its sense of humor, should be the one to propose the challenge to the new smartphone.
   In this example, the prompt template is over-fitted to the topic cell phone and is thus, not general to other topics (e.g., table, guitar, clown nose, duck, cup, piano, etc.).

To avoid instances of over-fitting, implementations of the present disclosure further provide for batch-based optimization. In some implementations, each iteration of the optimization process includes processing of multiple prompts generated using the prompt template that is to be optimized. Here, each iteration can include a training iteration and a validation iteration. The training iteration results in an updated version of a prompt template, and the validation iteration determines whether a next iteration (including another training iteration and validation iteration) is to be performed.

In further detail, during a training iteration of an iteration (i), a batch of prompts can be generated using a prompt template, each prompt being populated by different training data as dynamic input. Each prompt can be processed by a LLM, which provides a respective output. In this manner, a batch of outputs is provided. Each output in the batch of outputs is evaluated to provide a batch of evaluations. In some examples, for the training iteration, criticisms of the batch of evaluations are summarized to provide a criticism summary, which can be used to provide an updated version of the prompt template, as described herein.

In some examples, after the training iteration, a validation iteration is performed to evaluate the prompt template that results from the iteration (e.g., the updated version of the prompt template). For example, validation data is used to generate a batch of evaluation prompts that are used to prompt the LLM, which provides respective evaluation outputs. In this manner a batch of evaluation outputs is provided. Each evaluation output is scored, and the scores are combined (e.g., averaged) to determine a batch score. If the batch score is determined to be increasing with respect to an immediately previous iteration (i−1), the prompt template can be determined to be optimized. If the batch score is determined not to be increasing with respect to the immediately previous iteration (i−1), it can be determined to perform a next iteration (i+1) of optimization (including a training iteration and validation iteration).

By way of non-limiting example, an initial prompt template can be provided as:
Write a definition about {topic}
   After two (2) iterations of batch-based optimization, an updated version of the prompt template can be provided as:
Craft a witty and engaging description for {topic}, using elements of humor such as puns, wordplay, or amusing stories. Also, include elements of anthropomorphism to bring the topic to life.
   After ten (10) iterations of batch-based optimization, an updated version of the prompt template can be provided as:
Create a brief, entertaining tale centered around {topic}, using witty wordplay and puns to infuse humor. The topic should be given a unique personality and characteristics to make the narrative more engaging. The humor should be light-hearted and not rely heavily on specific knowledge or intricate metaphors. Keep the story concise to ensure the humor remains impactful and effective.

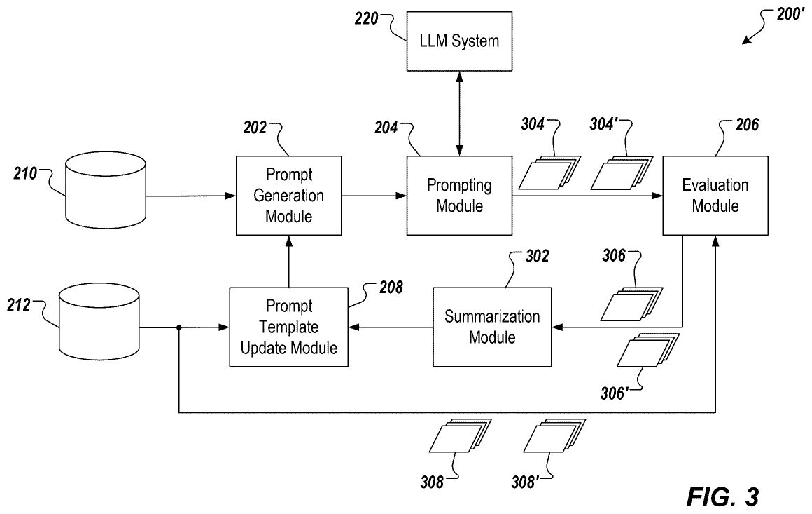

FIG. 3 depicts an example conceptual architecture 200′ in accordance with implementations of the present disclosure. In the depicted example, the conceptual architecture 200′ includes the components of the conceptual architecture 200 of FIG. 2, and further includes a summarization module 302. The example conceptual architecture 200′ of FIG. 3 can be used to perform batch-based optimization, as described herein.

In some implementations, during a training iteration of an iteration (i), the prompt generation module 202 generates a batch of prompts using a prompt template from the data store 210 and training data from the data store 212. For example, and with reference to the non-limiting examples above, a batch of prompts can include the following example prompts:
Write a definition about cell phone.
Write a definition about table.
Write a definition about guitar.
Write a definition about duck.
   Here, a batch size of 4 is provided. In some examples, the prompt generation module 202 generates each prompt by replacing placeholders with training data (e.g., as dynamic input).

In some implementations, the prompting module 204 prompts the LLM of the LLM system 220 using each prompt in the batch of prompts from the prompt generation module 202. For example, the prompting module 204 can make API calls to the LLM system 220, each call including a prompt in the batch of prompts. The LLM system 220 processes each prompt and returns a response as output, which is provided to the evaluation module 206. Accordingly, a batch of outputs 304 for the iteration (i) is provided to the evaluation module 206.

In some implementations, for the training iteration, the evaluation module 206 provides a batch of evaluations 306 for the iteration (i) that evaluate the outputs in the batch of outputs 304. For example, each evaluation in the batch of evaluations 306 can include a criticism (e.g., in natural language). In some examples, each evaluation in the batch of evaluations 306 is provided from the LLM system 220 in response to respective evaluation prompts provided by the evaluation module 206. For example, the evaluation module 206 can generate an evaluation prompt for each output in the batch of outputs 304 and prompts the LLM of the LLM system 220 using the evaluation prompt. For example, the evaluation module 206 can make API calls to the LLM system 220, each call including an evaluation prompt, where the LLM system 220 returns an evaluation. In some examples, evaluations in the batch of evaluations 306 can each be provided as a reference-based evaluation (e.g., based on a batch of desired outputs 308), as described herein. In some examples, evaluations in the batch of evaluations 306 can each be provided as a reference-free evaluation, as described herein.

In the training iteration, a criticism summary is provided by the summarization module 302. For example, the summarization module 302 provides a criticism summary prompt that is at least partially based on the criticisms of the batch of evaluations 306. In some examples, the summarization module 302 can make an API call to the LLM system 220, the call including the criticism summary prompt, where the LLM system 220 returns the criticism summary.

In the training iteration, the prompt template update module 208 updates the prompt template that has been used to provide the batch of outputs 304. For example, the prompt template module 208 provides an update prompt that is at least partially based on the criticism summary provided by the summarization module 302. In some examples, the update prompt is at least partially based on the prompt template. For example, the update prompt can request that an updated version of the prompt template be provided based on the criticism summary. In some examples, the prompt template update module 208 can make an API call to the LLM system 220, the call including the update prompt, where the LLM system 220 returns the updated version of the prompt template. The updated version of the prompt template is provided to the prompt generation module 202 and the validation iteration is performed.

In the validation iteration of the iteration (i), validation prompts are generated by the prompt generation module 202 using the updated version of the prompt template and validation data provided from the data store 210. In some examples, the validation data includes training data that was not used during the training iterations. In some examples, the validation data includes training data that was used during the training iterations. For example, example validation prompts can be provided as: example prompts:
Write a definition about computer.
Write a definition about cup.
Write a definition about guitar.
Write a definition about piano.
   Here, a batch size of 4 is provided (same as the training iteration). In some examples, the prompt generation module 202 generates each prompt by replacing placeholders with validation data (e.g., as dynamic input).

In some implementations, the prompting module 204 prompts the LLM of the LLM system 220 using each validation prompt in the batch of validation prompts from the prompt generation module 202. For example, the prompting module 204 can make API calls to the LLM system 220, each call including a validation prompt in the batch of validation prompts. The LLM system 220 processes each validation prompt and returns a response as output, which is provided to the evaluation module 206. Accordingly, a batch of validation outputs 304′ for the iteration (i) is provided to the evaluation module 206.

In some implementations, for the validation iteration, the evaluation module 206 provides a batch of validation evaluations 306′ for the iteration (i) that evaluate the validation outputs in the batch of validation outputs 304′. For example, each validation evaluation in the batch of validation evaluations 306′ can include one or more scores (e.g., groundness score, conciseness score, coherence scores, custom score). In some examples, each validation evaluation in the batch of validation evaluations 306′ is provided from the LLM system 220 in response to respective evaluation prompts provided by the evaluation module 206. For example, the evaluation module 206 can generate an evaluation prompt for each validation output in the batch of validation outputs 304′ and prompts the LLM of the LLM system 220 using the evaluation prompt. For example, the evaluation module 206 can make API calls to the LLM system 220, each call including an evaluation prompt, where the LLM system 220 returns a validation evaluation. In some examples, validation evaluations in the batch of validation evaluations 306′ can each be provided as a reference-based evaluation (e.g., based on a batch of desired outputs 308′), as described herein. In some examples, validation evaluations in the batch of validation evaluations 306′ can each be provided as a reference-free evaluation, as described herein.

In the validation iteration, a batch score is provided by the summarization module 302. For example, the summarization module 302 provides a batch score as a combination of scores provided in the batch of validation evaluations 306′. For example, the batch score can be provided as an average groundness score across the validation evaluations in the batch of validation evaluations 306′. As another example, the batch score can be provided as an average conciseness score across the validation evaluations in the batch of validation evaluations 306′. As another example, the batch score can be provided as an average coherence score across the validation evaluations in the batch of validation evaluations 306′. As another example, the batch score can be provided as an average custom score (e.g., funniness) across the validation evaluations in the batch of validation evaluations 306′.

In the validation iteration, it is determined whether the batch score of the current iteration (i) is greater than the batch score determined for a previous iteration (i−1). That is, it can be determined whether the batch score is increasing with respect to the previous iteration (i−1). In some examples, the batch score can be initialized to zero (0) prior to execution of a first iteration. In some examples, the prompt template update module 208 can receive the batch score from the summarization module 302 to determine whether the batch score is increasing. If the batch score is increasing, another iteration (i+1) of the optimization is performed. For example, a training iteration is performed using the updated version of the prompt template to generate a next updated version of the prompt template, and a validation iteration is performed to validate the next updated version of the prompt template. If the batch score is not increasing, no further iteration of the optimization is performed. In some examples, a last updated version of the prompt template is used as the optimized prompt template (e.g., the updated version of the prompt template used in the previous iteration (i−1)).

Although implementations of the present disclosure are described herein with non-limiting reference to an example use case, namely, generating a funny story based on a topic and a prompt template, implementations of the present disclosure can be used for enterprise-level use cases. For example, implementations of the present disclosure can be used to support workflows in enterprise operations.

By way of non-limiting example, an example enterprise-level use case can include a LLM-based compensation assistant for compensation discussions. In this example use case, a prompt template can be optimized in accordance with implementations of the present disclosure and can be used to generate compensation insights using a LLM. In this non-limiting example, an initial prompt template can be provided as:
You're a very experienced compensation assistant who has 20 years of experience under your belt. You are to help me, the employee's manager with a task that will be told shortly, using the following data:
Within the following triple backticks is the latest job information of my employee
. . .
{employee_job_info}
. . .
Within the following triple backticks is the compensation history of my employee
. . .
{employee_comp_history}.
. . .
Within the following triple backticks is information containing my employee's bonus payments
. . .
{employee_bonus_history}
. . .
Your task is to analyze the following data given to you and create a detailed summary of an individual employee's compensation. In order to create the summary, you need to analyze three datasets which will be given shortly: the recurring compensation data and one-time compensation data of the employee, and compensation data for other employees in the company. Specifically, you are to follow the steps as described to you:
STEP 1: Analyze the recurring compensation data for past few years for the employee and summarize salary trends of the employee in one paragraph. Include increment percentage of salary in the analysis. To calculate increment percentage of salary, let's think it step by step: for example, if an employee has a base salary of 100000 in 2020 and 105000 in 2021, the absolute increment is 105000−100000=5000, then increment percentage should be 5000/100000=5%. This paragraph goes into “Salary Trends” section.
STEP 2: Analyze the one-time compensation data for past few years for the employee and summarize bonus trends of the employee in one paragraph. This paragraph goes into “Bonuses” section.
STEP 3: Combine the two above analysis, compare it to the compensation data for other employees in the company, and give a summary of compensation data for other employees in the company. This paragraph goes into “Comparison” section.
   The initial prompt template can be used to generate the following example output from a LLM for a particular person:
STEP 1: Salary Trends
Danilo Pavel, with the user id BR0022, has shown a consistent upward trend in his annual salary over the past few years. Starting from a base salary of 100,000 EUR in 2019, he received a 5% increase in 2020, bringing his salary to 105,000 EUR. This was followed by another 1% increase in May 2020, taking his salary to 106,000 EUR. In 2021, he received a significant 0.47% increase in March, bringing his salary to 106,500 EUR, and another 0.45% increase in August, taking his salary to 110,000 EUR. His most recent salary increment in March 2022 was 0.91%, bringing his annual salary to 111,000 EUR. Overall, Danilo's salary has increased by approximately 11% over the past three years.
STEP 2: Bonuses
In terms of one-time compensation, Danilo has received spot bonuses and bonus payouts over the past two years. In March 2020, he received a spot bonus of 1,000 EUR for his work on project abc. In 2021, he received another spot bonus of 1,000 EUR for the same project. Additionally, he received a significant bonus payout of 25,000 EUR in March 2021, which was attributed to his 100% achievement of goals and company goals for the year 2020.
STEP 3: Comparison
When comparing Danilo's compensation to other employees in the company, it is evident that his salary increments and bonuses are reflective of his performance and contribution to the company. His consistent salary increments indicate a recognition of his growing skills and experience, while his bonus payouts highlight his ability to meet and exceed set goals. However, without specific data on other employees' compensation, it is difficult to make a direct comparison. It would be beneficial to analyze the average salary increments and bonus payouts within the company to gain a better understanding of how Danilo's compensation compares.

The initial prompt template can be optimized in accordance with implementations of the present disclosure to provide the following example optimized prompt template (e.g., after ten (10) iterations):
As a compensation assistant with extensive experience, your role is to help me, the manager, understand the compensation details of my employee. You will be provided with the following data:
Within the following triple backticks is the latest job information of my employee
. . .
{employee_job_info}
. . .
Within the following triple backticks is the compensation history of my employee
. . .
{employee_comp_history}
. . .
Within the following triple backticks is information containing my employee's bonus payments.
. . .
{employee_bonus_history}
. . .
Your task is to analyze this data and create a comprehensive summary of the employee's compensation, including their job progression, pay band position, and suggested talking points for a potential discussion with the employee. Please follow these steps:
STEP 1: Begin with a brief “Employee Summary” section, including the employee's user id, hire date, current position, job code, and the most recent effective date for their job information.
STEP 2: Analyze the recurring compensation data for the past few years for the employee and summarize salary trends. Include the increment percentage of salary in the analysis. This information should be included in the “Compensation History” section.
STEP 3: Analyze the one-time compensation data for the past few years for the employee and summarize bonus trends. This information should be included in the “Once-off Payments” section.
STEP 4: Analyze the employee's job progression since their hire date, including their current position and how long they have been in this role. This information should be included in the “Job Progression” section.
STEP 5: Compare the employee's compensation to the company's typical pay range for their role. This information should be included in the “Pay Band Position” section.
STEP 6: Based on the above analysis, suggest talking points for a potential discussion with the employee. This should include potential salary adjustments, recognition of performance, career progression, and explanation of the company's compensation structure. This information should be included in the “Suggested Talking Points” section.
   The optimized prompt template can be used to generate the following example output from the LLM for a particular person:
Employee Summary
The employee, Danilo Pavel, with user id BR0022, was hired on 1 Jan. 2008. He is currently in the position with id 984834, which he entered on 1 Jan. 2017. His job code is 9038204, and the most recent effective date for his job information is 1 May 2022.
Insights
Compensation History
Danilo's salary has seen a steady increase over the past few years. His annualized salary was €100,000 in March 2019, which increased to €105,000 in March 2020, €106,000 in May 2020, €106,500 in March 2021, €110,000 in August 2021, and €111,000 in March 2022. This represents an average annual increment of approximately 3.38. The increases have been due to on-cycle merit-based increases, inflation-based adjustments, and off-cycle pay changes due to exceptional performance.
Once-off Payments
Danilo has received spot bonuses of €1,000 in March 2020 and March 2021 for his work on project abc. Additionally, he received a bonus payout of €25,000 in March 2021 for achieving 100% of his goals and the company's goals in 2020.
Job Progression
Since his hire date in 2008, Danilo has progressed to his current position (id 984834), which he entered in 2017. This means he has been in his current role for approximately 5 years.
Pay Band Position
Danilo's current salary of €111,000 is within the company's pay range for his role (€96,000-€144,000). His salary is closer to the midpoint of the pay range (€120,000), with a compa ratio of 0.93.
Suggested Talking Points
1. Recognition of Danilo's consistent performance, as evidenced by his steady salary increases and bonus payments.
2. Discussion on his career progression and potential future opportunities within the company.
3. Explanation of the company's compensation structure, including how the pay range for his role is determined and how his current salary fits within this range.
4. Potential salary adjustments, considering his performance, the market rate for his role, and the company's budget.

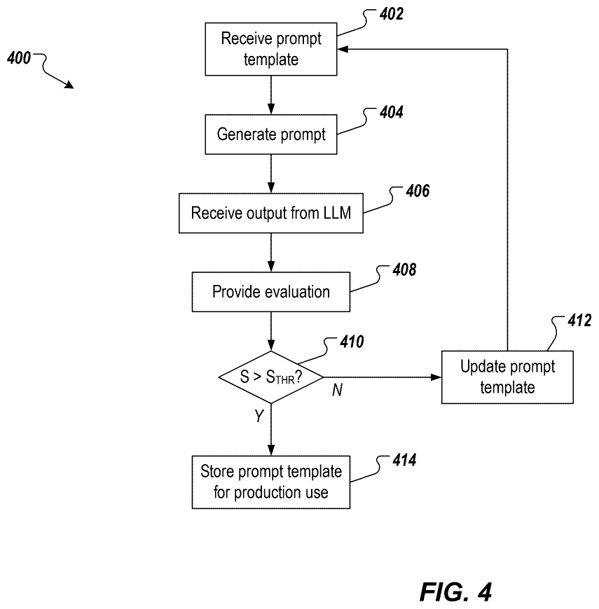

FIG. 4 depicts an example process 400 that can be executed in accordance with implementations of the present disclosure. In some examples, the example process 400 is provided using one or more computer-executable programs executed by one or more computing devices.

A prompt template is received (402). For example, and as described herein with reference to FIG. 2, a prompt template that is to be optimized is received by the prompt generation module 202. In some examples, the prompt template is an initial version for an initial iteration of optimization. In some examples, the prompt template is an updated version for a next iteration of optimization. A prompt is generated (404). For example, and as described herein, the prompt generation module 202 populates the prompt template with training data to provide a prompt. Output is received from a LLM (406). For example, and as described herein, the prompting module 204 prompts the LLM system 220 using the prompt, the LLM system 220 processing the prompt through a LLM and returning the output 230 that is responsive to the prompt.

An evaluation is provided (408). For example, and as described herein, the evaluation module 206 provides the evaluation 232 that includes one or more scores and a criticism. In some examples, the evaluation module 206 can generate the evaluation prompt at least partially based on the output 230 and prompts the LLM of the LLM system 220 using the evaluation prompt. For example, the evaluation module 206 can make an API call to the LLM system 220, the call including the evaluation prompt, where the LLM system 220 returns the evaluation 232.

It is determined whether the score exceeds a threshold score (410). If the score does not exceed the threshold score, the prompt template is updated (412) and the example process 400 loops back to perform a next iteration of optimization. For example, and as described herein, the prompt template update module 208 provides an update prompt that is at least partially based on the evaluation 232. For example, the update prompt can include the criticism of the evaluation 232. In some examples, the update prompt is at least partially based on the prompt template. For example, the update prompt can request that an updated version of the prompt template be provided based on the criticism. In some examples, the prompt template update module 208 can make an API call to the LLM system 220, the call including the update prompt, where the LLM system 220 returns the updated version of the prompt template. The updated version of the prompt template is provided to the prompt generation module 202, which executes a next iteration (i+1) of optimizing the prompt template. If the score does exceed the threshold score, the prompt template is stored for production use (414). For example, the prompt template can be stored in a production prompt template store and can be used to generate prompts for prompting a LLM during tasks of enterprise-level workflows.

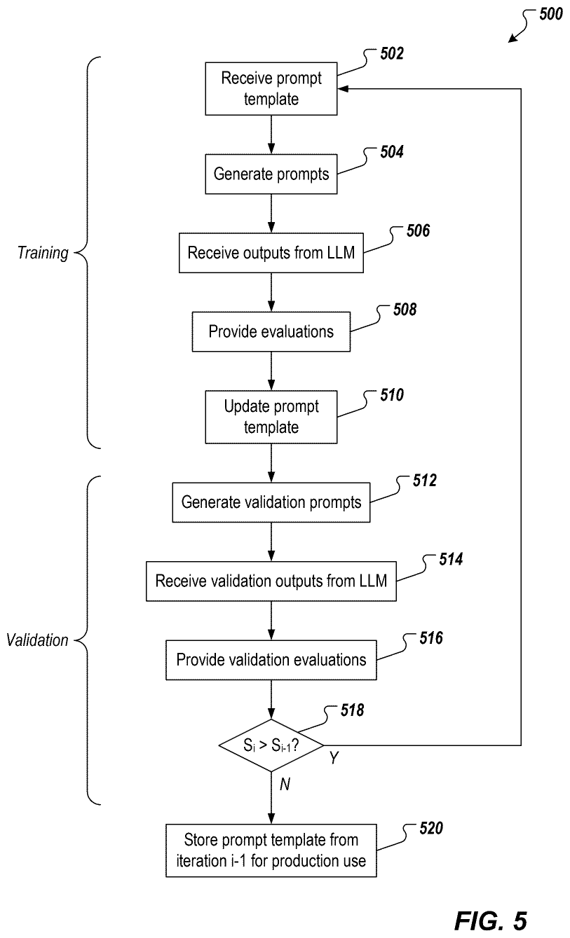

FIG. 5 depicts an example process 500 that can be executed in accordance with implementations of the present disclosure. In some examples, the example process 500 is provided using one or more computer-executable programs executed by one or more computing devices. In some examples, the example process 500 is representative of batch-based optimization.

A prompt template is received (502). For example, and as described herein with reference to FIG. 3, a prompt template that is to be optimized is received by the prompt generation module 202. In some examples, the prompt template is an initial version for an initial iteration of optimization. In some examples, the prompt template is an updated version for a next iteration of optimization. A batch of prompts is generated (504). For example, and as described herein, the prompt generation module 202 populates the prompt template with multiple instances of training data to provide a batch of prompts. Outputs are received from a LLM (406). For example, and as described herein, the prompting module 204 prompts the LLM system 220 using each prompt in the batch of prompts, the LLM system 220 processing each prompt through a LLM and returning a respective output that is responsive to the prompt, thus providing the batch of outputs 304.

Evaluations are provided (408). For example, and as described herein, the evaluation module 206 provides a batch of evaluations 306, each evaluation including a criticism (natural language). In some examples, the evaluation module 206 can generate evaluation prompts at least partially based on the batch of outputs 304 and prompts the LLM of the LLM system 220 using the evaluation prompts. For example, the evaluation module 206 can make API calls to the LLM system 220, each call including an evaluation prompt, where the LLM system 220 returns a respective evaluation, thus providing the batch of evaluations 306.

The prompt template is updated (510). For example, and as described herein, the summarization module 302 provides a criticism summary prompt that is at least partially based on the criticisms of the batch of evaluations 306. In some examples, the summarization module 302 can make an API call to the LLM system 220, the call including the criticism summary prompt, where the LLM system 220 returns the criticism summary. The prompt template update module 208 provides an update prompt that is at least partially based on the criticism summary. For example, the update prompt can include the criticism summary. In some examples, the update prompt is at least partially based on the prompt template. For example, the update prompt can request that an updated version of the prompt template be provided based on the criticism summary. In some examples, the prompt template update module 208 can make an API call to the LLM system 220, the call including the update prompt, where the LLM system 220 returns the updated version of the prompt template.

Validation prompts are generated (512). For example, and as described herein, validation prompts are generated by the prompt generation module 202 using the updated version of the prompt template and validation data provided from the data store 210. In some examples, the validation data includes training data that was not used during the training iterations. In some examples, the validation data includes training data that was used during the training iterations. Validation outputs are received from the LLM (514). For example, and as described herein, the prompting module 204 prompts the LLM of the LLM system 220 using each validation prompt in the batch of validation prompts from the prompt generation module 202. For example, the prompting module 204 can make API calls to the LLM system 220, each call including a validation prompt in the batch of validation prompts. The LLM system 220 processes each validation prompt and returns a response as output, which is provided to the evaluation module 206. Accordingly, the batch of validation outputs 304′ for the iteration (i) is provided to the evaluation module 206.

Validation evaluations are provided (516). For example, and as described herein, the evaluation module 206 provides a batch of validation evaluations 306′ for the iteration (i) that evaluate the validation outputs in the batch of validation outputs 304′. For example, each validation evaluation in the batch of validation evaluations 306′ can include one or more scores (e.g., groundness score, conciseness score, coherence scores, custom score). In some examples, each validation evaluation in the batch of validation evaluations 306′ is provided from the LLM system 220 in response to respective evaluation prompts provided by the evaluation module 206. For example, the evaluation module 206 can generate an evaluation prompt for each validation output in the batch of validation outputs 304′ and prompts the LLM of the LLM system 220 using the evaluation prompt. For example, the evaluation module 206 can make API calls to the LLM system 220, each call including an evaluation prompt, where the LLM system 220 returns a validation evaluation.

A batch score is provided by the summarization module 302. For example, the summarization module 302 provides a batch score as a combination of scores provided in the batch of validation evaluations 306′. It is determined whether the batch score of the current iteration (i) exceeds the batch score of the immediately previous iteration (i−1) (518). If the batch score of the current iteration (i) does not exceed the batch score of the immediately previous iteration (i−1), the example process 500 loops back to perform a next iteration of optimization (e.g., starting with the updated version of the prompt template from (510)). If the batch score of the current iteration (i) exceeds the batch score of the immediately previous iteration (i−1), the updated version of the prompt template provided in the immediately previous iteration (i−1) is stored for production use (520).

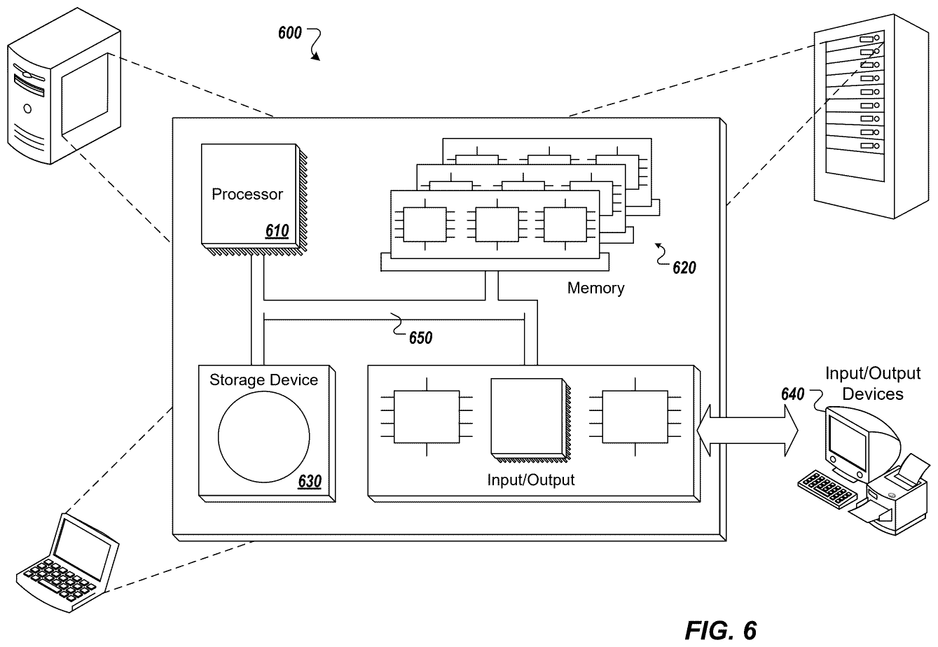

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for optimization of prompt templates for prompting large language models (LLMs), the method being executed by one or more processors and comprising:
providing an initial version of a prompt template, the prompt template comprising dynamic input and first static input;
generating a prompt using the initial version of the prompt template at least partially by populating the dynamic input with training data;
receiving, from a LLM, an output that is responsive to the prompt;
providing an evaluation at least partially based on the output; and
selectively updating the prompt template to provide an updated version of the prompt template by prompting the LLM at least partially based on the evaluation, the updated version of the prompt template comprising second static input that is generated by the LLM and that is different from the first static input.

2. The method of claim 1, wherein the prompt template is updated at least partially in response to a score of the evaluation indicating that the prompt template is to be updated, the score being provided by the LLM in response to an evaluation prompt.

3. The method of claim 1, wherein two or more iterations of updating the prompt template are performed until a score exceeds a threshold score, the score representing an evaluation metric associated with the prompt template.

4. The method of claim 1, wherein two or more iterations of updating the prompt template are performed until a value of a score fails to exceed a prior value of the score, the score representing an evaluation metric associated with the prompt template.

5. The method of claim 1, wherein updating the prompt template comprises prompting the LLM using an update prompt that is at least partially based on the evaluation and the prompt template, the LLM returning the updated version of the prompt template in response to the update prompt.

6. The method of claim 1, wherein the evaluation is provided by prompting the LLM using an evaluation prompt that is at least partially based on the output, the LLM returning the evaluation in response to the evaluation prompt.

7. The method of claim 1, wherein the prompt is included in a batch of prompts used to prompt the LLM, the output is included in a batch of outputs returned from the LLM, and the evaluation is determined from a batch of evaluations.

8. A non-transitory computer-readable storage medium coupled to one or more processors and having instructions stored thereon which, when executed by the one or more processors, cause the one or more processors to perform operations for optimization of prompt templates for prompting large language models (LLMs), the operations comprising:
providing an initial version of a prompt template, the prompt template comprising dynamic input and first static input;
generating a prompt using the initial version of the prompt template at least partially by populating the dynamic input with training data;
receiving, from a LLM, an output that is responsive to the prompt;
providing an evaluation at least partially based on the output; and
selectively updating the prompt template to provide an updated version of the prompt template by prompting the LLM at least partially based on the evaluation, the updated version of the prompt template comprising second static input that is generated by the LLM and that is different from the first static input.

9. The non-transitory computer-readable storage medium of claim 8, wherein the prompt template is updated at least partially in response to a score of the evaluation indicating that the prompt template is to be updated, the score being provided by the LLM in response to an evaluation prompt.

10. The non-transitory computer-readable storage medium of claim 8, wherein two or more iterations of updating the prompt template are performed until a score exceeds a threshold score, the score representing an evaluation metric associated with the prompt template.

11. The non-transitory computer-readable storage medium of claim 8, wherein two or more iterations of updating the prompt template are performed until a value of a score fails to exceed a prior value of the score, the score representing an evaluation metric associated with the prompt template.

12. The non-transitory computer-readable storage medium of claim 8, wherein updating the prompt template comprises prompting the LLM using an update prompt that is at least partially based on the evaluation and the prompt template, the LLM returning the updated version of the prompt template in response to the update prompt.

13. The non-transitory computer-readable storage medium of claim 8, wherein the evaluation is provided by prompting the LLM using an evaluation prompt that is at least partially based on the output, the LLM returning the evaluation in response to the evaluation prompt.

14. The non-transitory computer-readable storage medium of claim 8, wherein the prompt is included in a batch of prompts used to prompt the LLM, the output is included in a batch of outputs returned from the LLM, and the evaluation is determined from a batch of evaluations.

15. A system, comprising:
a computing device; and
a computer-readable storage device coupled to the computing device and having instructions stored thereon which, when executed by the computing device, cause the computing device to perform operations for optimization of prompt templates for prompting large language models (LLMs), the operations comprising:
providing an initial version of a prompt template, the prompt template comprising dynamic input and first static input,
generating a prompt using the initial version of the prompt template at least partially by populating the dynamic input with training data,
receiving, from a LLM, an output that is responsive to the prompt,
providing an evaluation at least partially based on the output, and
selectively updating the prompt template to provide an updated version of the prompt template by prompting the LLM at least partially based on the evaluation, the updated version of the prompt template comprising second static input that is generated by the LLM and that is different from the first static input.

16. The system of claim 15, wherein the prompt template is updated at least partially in response to a score of the evaluation indicating that the prompt template is to be updated, the score being provided by the LLM in response to an evaluation prompt.

17. The system of claim 15, wherein two or more iterations of updating the prompt template are performed until a score exceeds a threshold score, the score representing an evaluation metric associated with the prompt template.

18. The system of claim 15, wherein two or more iterations of updating the prompt template are performed until a value of a score fails to exceed a prior value of the score, the score representing an evaluation metric associated with the prompt template.

19. The system of claim 15, wherein updating the prompt template comprises prompting the LLM using an update prompt that is at least partially based on the evaluation and the prompt template, the LLM returning the updated version of the prompt template in response to the update prompt.

20. The system of claim 15, wherein the evaluation is provided by prompting the LLM using an evaluation prompt that is at least partially based on the output, the LLM returning the evaluation in response to the evaluation prompt.
